(19) United States
(12) Patent Application Publication
(10) Pub. No.: US 2021/0269217 A1
(43) Pub. Date: Sep. 2, 2021

(54) CUSHIONING PAD AND CUSHIONING APPARATUS

(71) Applicants: CHONGQING HKC OPTOELECTRONICS TECHNOLOGY CO., LTD., Chongqing (CN); HKC CORPORATION LIMITED, shenzhen (CN)

(72) Inventors: Wenqiang BAO, Chongqing (CN); QIONG WU, Chongqing (CN)

(21) Appl. No.: 17/274,438

(22) PCT Filed: Dec. 6, 2018
(86) PCT No.: PCT/CN2018/119550

§ 371 Date: Mar. 9, 2021

(30) Foreign Application Priority Data
Sep. 30, 2018 (CN) 201821629516.2

(51) Int. Cl. B65D 81/05; B65D 85/30; B65G 49/06

(52) U.S. Cl. CPC B65D 81/05; B65G 2207/42; B65G 49/061; B65D 85/30

(57) ABSTRACT

This application discloses a cushioning pad and a cushioning apparatus. The cushioning pad includes a body and a positioning adsorption structure. The body is arranged to separate a display panel; and the positioning adsorption structure is arranged on a surface of the body for adsorption by a suction nozzle of a machine. An upper surface area of the positioning adsorption structure is greater than a vacuum adsorption area of the suction nozzle. An upper surface of the positioning adsorption structure corresponding to the suction nozzle is a smooth plane. There are at least two positioning adsorption structures, and the positioning adsorption structures are symmetrically distributed.

### CROSS REFERENCE OF RELATED APPLICATIONS

This application claims the priority to the Chinese Patent Application No. CN201821629516.2, filed with National Intellectual Property Administration, PRC on Sep. 30, 2018 and entitled “CUSHIONING PAD AND CUSHIONING APPARATUS”, which is incorporated herein by reference in its entirety.

### TECHNICAL FIELD

This application relates to the field of display technologies, and in particular, to a cushioning pad and a cushioning apparatus.

### BACKGROUND

The statements herein only provide background information related to this application, and do not necessarily constitute prior art.

Displays that adopt active switch control include liquid crystal displays and organic light-emitting diode (OLED) displays, etc. Liquid crystal displays are widely used due to many advantages, such as a thin body, power-saving, and no radiation, etc. A working principle of a liquid crystal panel is to place liquid crystal molecules between two parallel glass substrates, and apply a driving voltage on the two glass substrates to control a rotation direction of the liquid crystal molecules, so as to refract light from a backlight module to generate an image. Organic light-emitting diode displays have many advantages such as self-luminescence, a short response time, high definition and contrast, flexible displaying, and large-area full-color displaying, etc. Superior performance and a huge market potential of the organic light-emitting diode display attract many manufacturers and scientific research institutions around the world to invest in production and research and development of organic light-emitting diode display panels.

Cushioning pads are usually placed between fragile products for cushioning, so as to prevent the fragile products from breaking. Most cushioning pads are made of soft materials. When a machine adsorbs the cushioning pad, an adsorption failure is likely to occur.

### SUMMARY

In view of the above disadvantages, this application provides a cushioning pad and a cushioning apparatus that improve a success rate of adsorption. In order to achieve the above objective, this application provides a cushioning pad, including: a body arranged to separate a display panel; and a positioning adsorption structure arranged on a surface of the body for adsorption by a suction nozzle of a machine. An upper surface of the positioning adsorption structure corresponding to the suction nozzle is a smooth plane.

Optionally, an upper surface area of the positioning adsorption structure is greater than a vacuum adsorption area of the suction nozzle.

Optionally, there are at least two positioning adsorption structures.

Optionally, the positioning adsorption structures are symmetrically distributed.

Optionally, the body includes a first groove configured to arrange the positioning adsorption structure.

Optionally, a thickness of the positioning adsorption structure is less than a depth of the first groove.

Optionally, the body includes a second groove, where the second groove is a through groove penetrating the body.

Optionally, the second grooves are symmetrically distributed.

Optionally, the cushioning pad includes a first groove and a second groove, where the first groove and the second groove have different shapes.

Optionally, the first groove and the second groove are separately distributed.

Optionally, the second grooves are distributed in a rectangle, and the second grooves are respectively located at four corners of the rectangle.

Optionally, the body includes an upper film layer, a lower film layer, and an intermediate layer arranged between upper film layer and the lower film layer.

Optionally, the intermediate layer is made of foam.

Optionally, the intermediate layer includes a plurality of circular holes.

Optionally, an outer surface of the upper film layer is uneven.

Optionally, an outer surface of the lower film layer is uneven.

This application further discloses a cushioning pad, including: a body arranged to separate a display panel; and a positioning adsorption structure arranged on a surface of the body for adsorption by a suction nozzle of a machine. An upper surface of the positioning adsorption structure corresponding to the suction nozzle is a smooth plane.

An upper surface area of the positioning adsorption structure is greater than a vacuum adsorption area of the suction nozzle.

There are at least two positioning adsorption structures.

The positioning adsorption structures are symmetrically distributed.

The body includes a first groove on which the positioning adsorption structure is arranged.

A thickness of the positioning adsorption structure needs to be less than a depth of the first groove.

This application further discloses a cushioning apparatus, including:

a body arranged to separate a display panel; and

a positioning adsorption structure arranged on a surface of the body for adsorption by a suction nozzle of a machine.

An upper surface of the positioning adsorption structure corresponding to the suction nozzle is a smooth plane.

Optionally, an upper surface area of the positioning adsorption structure is greater than a vacuum adsorption area of the suction nozzle.

Optionally, there are at least two positioning adsorption structures.

Optionally, the positioning adsorption structures are symmetrically distributed.

Optionally, the body includes a first groove on which the positioning adsorption structure is disposed.

Optionally, a thickness of the positioning adsorption structure is less than a depth of the first groove.

Optionally, the body includes a second groove, where the second groove is a through groove penetrating the body.

Optionally, the cushioning pad includes a first groove and a second groove, where the first groove and the second groove have different shapes.

A surface of a common cushioning pad is uneven and not smooth, which may cause an adsorption failure during adsorption. Now the positioning adsorption structure is arranged on the surface of the cushioning pad, and the suction nozzle is adsorbed on a smooth plane of the positioning adsorption structure, so that adsorption is more stable.

### BRIEF DESCRIPTION OF DRAWINGS

The included accompanying drawings are used for providing further understanding of the embodiments of this application, constitute a part of the specification, and are used to illustrate implementations of this application and explain the principle of this application together with literal descriptions. Apparently, the accompanying drawings in the following description show merely some embodiments of this application, and a person of ordinary skill in the art may still derive other accompanying drawings from these accompanying drawings without creative efforts. In the accompanying drawings:

FIG. 1 is a schematic diagram of a machine structure according to an embodiment of this application.

FIG. 2 is a schematic diagram of a cushioning pad structure (1) according to an embodiment of this application.

FIG. 3 is a schematic diagram of a cushioning pad structure (2) according to an embodiment of this application.

FIG. 4 is a schematic diagram of a cushioning pad surface structure (1) according to an embodiment of this application.

FIG. 5 is a schematic diagram of a cushioning pad surface structure (2) according to an embodiment of this application.

FIG. 6 is a schematic diagram of a display panel and a cushioning pad that are stacked according to an embodiment of this application.

FIG. 7 is a schematic diagram of a cushioning apparatus according to an embodiment of this application.

### DETAILED DESCRIPTION OF EMBODIMENTS

Specific structures and functional details disclosed herein are merely representative, and are intended to describe the objectives of the exemplary embodiments of this application. However, this application may be specifically implemented in many alternative forms, and should not be construed as being limited to the embodiments set forth herein.

In the description of this application, it should be understood that orientation or position relationships indicated by the terms such as “center”, “transverse”, “on”, “below”, “left”, “right”, “vertical”, “horizontal”, “top”, “bottom”, “inside”, and “outside” are based on orientation or position relationships shown in the accompanying drawings, and are used only for ease and brevity of illustration and description, rather than indicating or implying that the mentioned apparatus or component needs to have a particular orientation or needs to be constructed and operated in a particular orientation. Therefore, such terms should not be construed as limiting of this application. In addition, terms “first” and “second” are only used to describe the objective and cannot be understood as indicating or implying relative importance or implying a quantity of the indicated technical features. Therefore, features defining “first” and “second” can explicitly or implicitly include one or more features. In the description of this application, unless otherwise stated, “a plurality of” means two or more than two. In addition, the terms “include”, “comprise” and any variant thereof are intended to cover non-exclusive inclusion.

In the description of this application, it should be noted that unless otherwise explicitly specified or defined, the terms such as “mount”, “install”, “connect”, and “connection” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components.

For a person of ordinary skill in the art, the specific meanings of the foregoing terms in this application may be understood according to specific situations.

The terminology used herein is for the purpose of describing specific embodiments only and is not intended to be limiting of exemplary embodiments. As used herein, the singular forms “a”, “an” and “the” are intended to include the plural forms as well, unless the context clearly indicates otherwise. It should be further understood that the terms “include” and/or “comprise” used in this specification specify the presence of stated features, integers, steps, operations, elements, and/or components, but do not preclude the presence or addition of one or more other features, integers, steps, operations, elements, components, and/or combinations thereof.

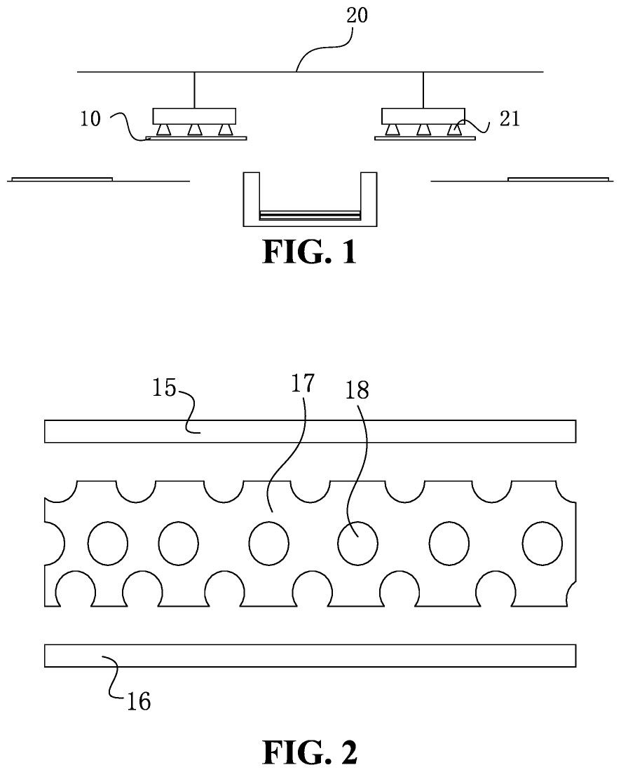

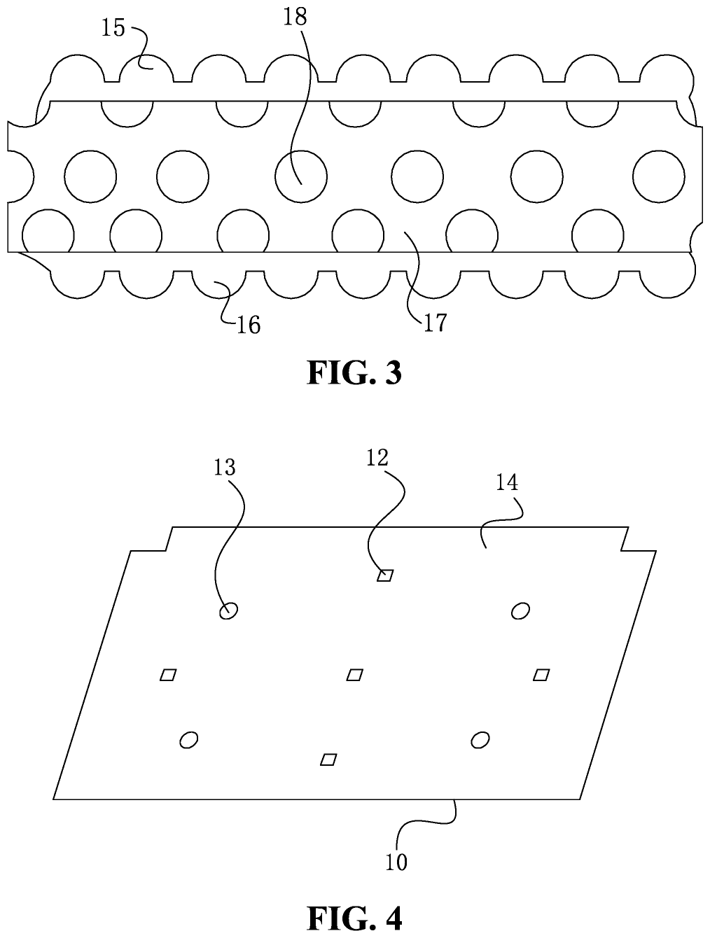

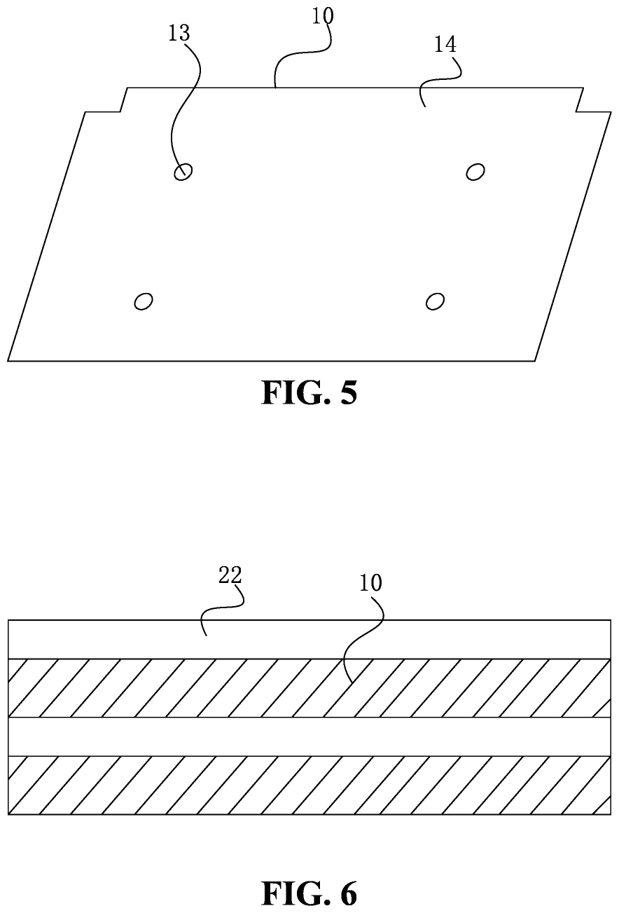

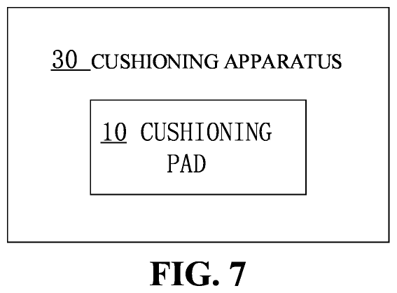

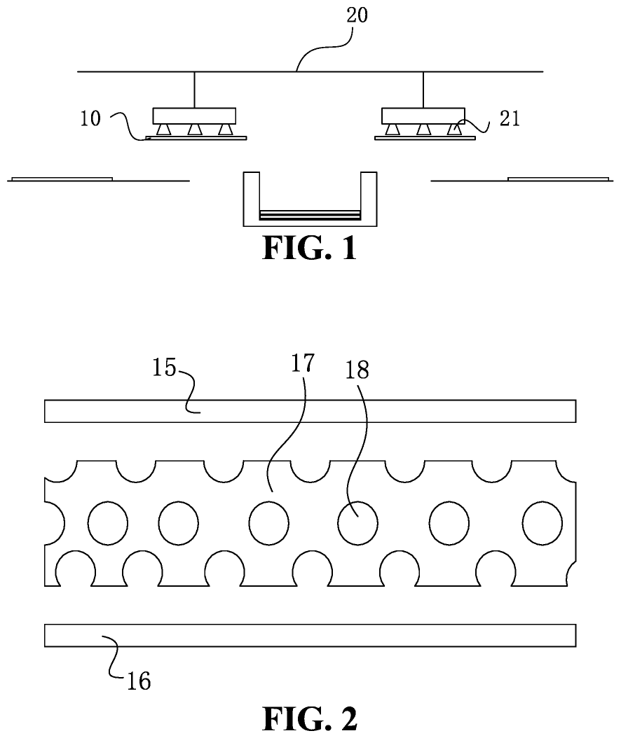

The applicant adopts a display panel turnover or shipping method. Two cushioning foams: a pearl cotton gasket and a polypropylene gasket are used as packaging materials for the display panel 22 for turnover or shipment. During turnover or packaging and shipping, a machine automatically adsorbs a gasket 10 and a display panel 22, and places the gasket and the display panel in a bubble box separately, which is shown in FIG. 1.

During the operation of the machine, a success rate of adsorbing the display panel 22 is 100%, but adsorption of the gasket 10 possibly fails. Two reasons for failing to adsorb the pearl cotton gasket are as follows:

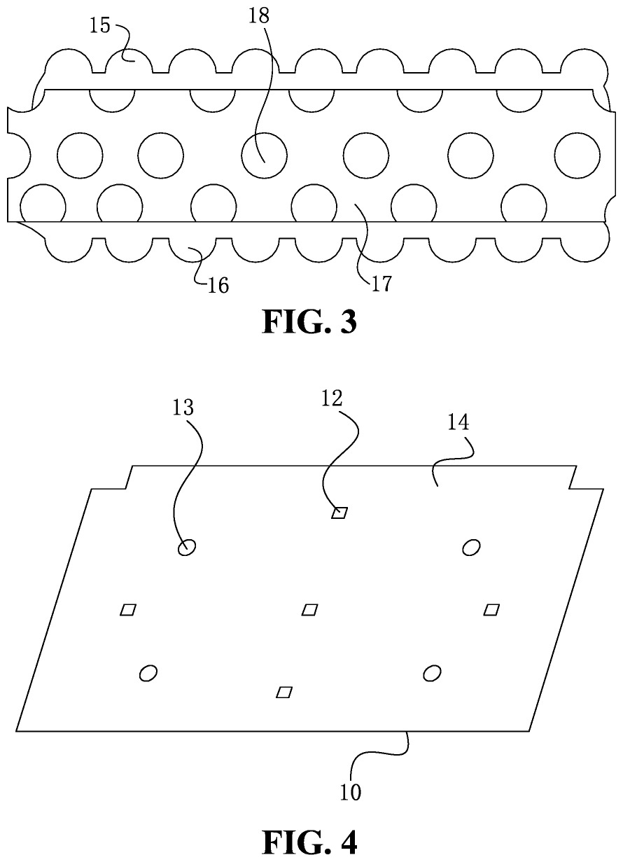

1. A manufacturing process of the pearl cotton gasket is to perform hot-pressing and attachment on an upper film layer 15, a lower film layer 16, and intermediate layer 17. The attachment process causes wave undulations and local warping, and severe undulations cause a vacuum adsorption failure of the machine, which are shown in FIG. 2 and FIG. 3.

2. The pearl cotton gasket has soft materials, which may be deformed, wrinkled, damaged by an external force during packaging in an original factory, transporting and shipping to a panel factory, or turnover and use in the panel factory, causing the vacuum adsorption failure of the machine.

A reason for failing to adsorb the polypropylene gasket is as follows:

The polypropylene gasket has hard materials. In order to achieve cushioning performance and avoid adhesion to the display panel, a surface of the polypropylene gasket needs to be silk-screened. The textures cause the machine to possibly fail during vacuum adsorption.

This application is further described below with reference to the drawings and exemplary embodiments.

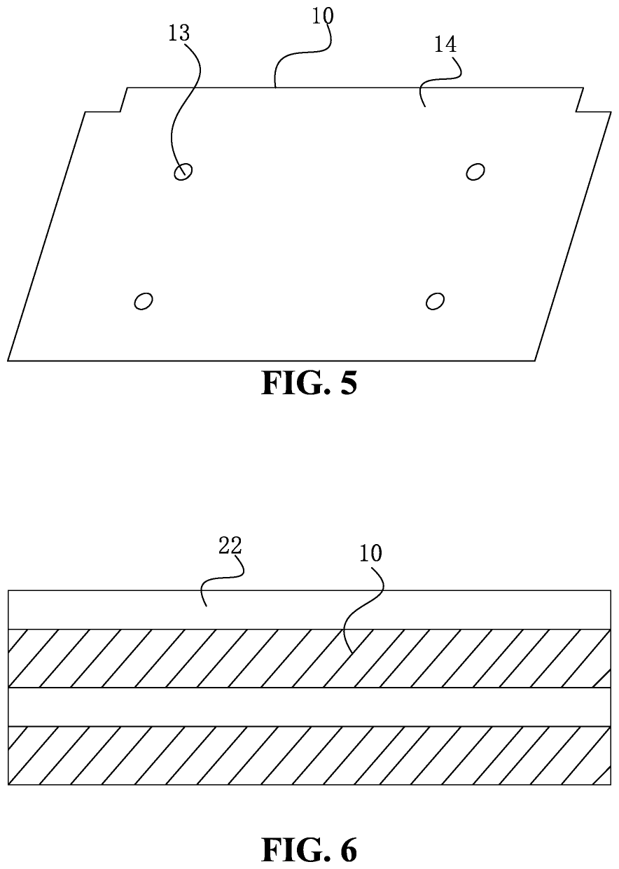

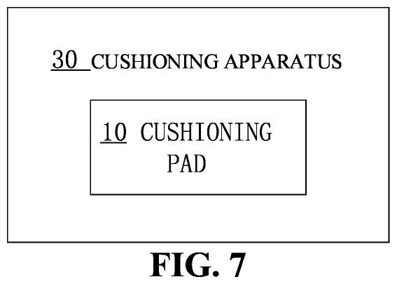

As shown in FIG. 1 to FIG. 7, an embodiment of this application discloses a cushioning pad 10, including: a body 14 arranged to separate a display panel 22; and a positioning adsorption structure 11 arranged on a surface of the body 14 for adsorption by a suction nozzle 21 of a machine 20. An upper surface of the positioning adsorption structure 11 corresponding to the suction nozzle 21 is a smooth plane.

Specifically, the body includes an upper film layer 15, a lower film layer 16, and an intermediate layer 17. The intermediate layer 17 is arranged between the upper film layer 15 and the lower film layer 16. The intermediate layer 17 is made of foam, and the intermediate layer 17 includes a plurality of circular holes 18, Outer surfaces of the upper film layer 15 and the lower film layer 16 are uneven.

In this solution, a surface of a common cushioning pad 10 is uneven and not smooth, which may cause an adsorption failure during adsorption. Now the positioning adsorption structure 11 is arranged on the surface of the cushioning pad 10, and the suction nozzle 21 is adsorbed on a smooth plane of the positioning adsorption structure 11, so that adsorption is more stable.

In an embodiment, an upper surface area of the positioning adsorption structure 11 is greater than a vacuum adsorption area of the suction nozzle 21.

In this solution, since the upper surface area of the positioning adsorption structure 11 is greater than the vacuum adsorption area of the suction nozzle 21, the suction nozzle 21 is completely adsorbed on the upper surface of the positioning adsorption structure 11, so that the suction nozzle 21 is adsorbed stably.

In an embodiment, there are at least two positioning adsorption structures 11.

In this solution, at least two positioning adsorption structures 11 are arranged, so that an adsorption area is correspondingly increased, and adsorption is more stable.

In an embodiment, the positioning adsorption structures 11 are symmetrically distributed.

In this solution, the positioning adsorption structures 11 are symmetrically distributed, and the suction nozzle 21 is adsorbed on the upper surface of each of the positioning adsorption structures 11, so that an adsorption force of the suction nozzle 21 to the cushioning pad 10 is evenly distributed, and the adsorption is more stable.

In an embodiment, the body 14 includes a first groove 12 on which the positioning adsorption structure 11 is disposed.

In this solution, during production, if directly arranged on the surface, the positioning adsorption structure 11 may be arranged at an inaccurate position. A groove is dug to arrange the positioning adsorption structure 11, so that an alignment effect is generated during production, reducing an alignment time.

In an embodiment, a thickness of the positioning adsorption structure 11 is less than a depth of the first groove 12.

In this solution, the cushioning pad 10 is compressed and deformed to some extent during working to generate a cushioning effect. The thickness of the positioning adsorption structure 11 is less than the depth of the first groove 12, to provide a deformation space without affecting the cushioning effect of the cushioning pad 10.

In an embodiment, the body 14 includes a second groove 13. The second groove 13 is a through groove penetrating the body 14.

In this solution, when the display panel 22 is being taken out, the display panel 22 and the cushioning pad 10 stick to each other. A through groove is arranged on the cushioning pad 10 for air ventilation, to prevent the display panel 22 and the cushioning pad 10 from sticking to each other.

In an embodiment, the second grooves 13 are symmetrically distributed. Specifically, the second grooves 13 are distributed in a rectangle, and the second grooves 13 are respectively located at four corners of the rectangle.

In this solution, the second grooves 13 are symmetrically distributed to avoid an adsorption failure of the machine 20 as a result of deformation of the cushioning pad 10 caused by uneven ventilation.

In an embodiment, the cushioning pad 10 includes a first groove 12 and a second groove 13. The first groove 12 and the second groove 13 have different shapes, and the first groove 12 and the second groove 13 are separately distributed.

In this solution, the first groove 12 and the second groove 13 are arranged in different shapes to facilitate observation and distinguish between the two grooves with different functions.

In another embodiment of this application, as shown in FIG. 1 to FIG. 7, a cushioning pad 10 is disclosed, including: a body 14 arranged to separate a display panel 22; and a positioning adsorption structure 11 arranged on a surface of the body 14 for adsorption by a suction nozzle 21 of a machine 20. An upper surface of the positioning adsorption structure 11 corresponding to the suction nozzle 21 is a smooth plane. An upper surface area of the positioning adsorption structure 11 is greater than a vacuum adsorption area of the suction nozzle 21. There are at least two positioning adsorption structures 11. The positioning adsorption structures 11 are symmetrically distributed. The body 14 includes a first groove 12 on which the positioning adsorption structure 11 is arranged. A thickness of the positioning adsorption structure 11 is less than a depth of the first groove 12.

In this solution, a surface of a common cushioning pad 10 is uneven and not smooth, which may cause an adsorption failure during adsorption. Now the positioning adsorption structure 11 is arranged on the surface of the cushioning pad 10, and the suction nozzle 21 is adsorbed on a smooth plane of the positioning adsorption structure 11, so that adsorption is more stable. Since upper surface area of the positioning adsorption structure 11 is greater than the vacuum adsorption area of the suction nozzle 21, the suction nozzle 21 is completely adsorbed on the upper surface of the positioning adsorption structure 11, so that the suction nozzle 21 is adsorbed stably. At least two positioning adsorption structures 11 are arranged, so that an adsorption area is correspondingly increased, and adsorption is more stable. The positioning adsorption structures 11 are symmetrically distributed, and the suction nozzle 21 is adsorbed on the smooth upper surface of the positioning adsorption structure 11, so that an adsorption force of the suction nozzle 21 to the cushioning pad 10 is evenly distributed, and the adsorption is more stable. During production, if directly adhered on the surface, the positioning adsorption structure 11 may be adhered at an inaccurate position. A groove is dug to arrange the positioning adsorption structure 11, so that an alignment effect is generated during production, reducing an alignment time. The cushioning pad 10 is compressed and deformed to some extent during working to generate a cushioning effect. The thickness of the positioning adsorption structure 11 needs to be less than the depth of the first groove 12, to provide a deformation space without affecting the cushioning effect of the cushioning pad 10.

In another embodiment of this application, as shown in FIG. 1 to FIG. 7, a cushioning apparatus 30 is disclosed. The cushioning apparatus includes: a body 14 is arranged to separate a display panel 22; and a positioning adsorption structure 11 arranged on a surface of the body 14 for adsorption by a suction nozzle 21 of a machine 20. An upper surface of the positioning adsorption structure 11 corresponding to the suction nozzle 21 is a smooth plane.

In this solution, a surface of a common cushioning pad 10 is uneven and not smooth, which may cause an adsorption failure during adsorption. Now the positioning adsorption structure 11 is arranged on the surface of the cushioning pad 10, and the suction nozzle 21 is adsorbed on a smooth plane of the positioning adsorption structure 11, so that adsorption is more stable.

In an embodiment, an upper surface area of the positioning adsorption structure 11 is greater than a vacuum adsorption area of the suction nozzle 21.

In this solution, since the upper surface area of the positioning adsorption structure 11 is greater than the vacuum adsorption area of the suction nozzle 21, the suction nozzle 21 is completely adsorbed on the upper surface of the positioning adsorption structure 11, so that the suction nozzle 21 is adsorbed stably.

In an embodiment, there are at least two positioning adsorption structures 11.

In this solution, at least two positioning adsorption structures 11 are arranged, so that an adsorption area is correspondingly increased, and adsorption is more stable.

In an embodiment, the positioning adsorption structures 11 are symmetrically distributed.

In this solution, the positioning adsorption structures 11 are symmetrically distributed, and the suction nozzle 21 is adsorbed on the upper surface of each of the positioning adsorption structures 11, so that an adsorption force of the suction nozzle 21 to the cushioning pad 10 is evenly distributed, and the adsorption is more stable.

In an embodiment, the body 14 includes a first groove 12 on which the positioning adsorption structure 11 is disposed.

In this solution, during production, if directly arranged on the surface, the positioning adsorption structure 11 may be arranged at an inaccurate position. A groove is dug to arrange the positioning adsorption structure 11, so that an alignment effect is generated during production, reducing an alignment time.

In an embodiment, a thickness of the positioning adsorption structure 11 is less than a depth of the first groove 12.

In this solution, the cushioning pad 10 is compressed and deformed to some extent during working to generate a cushioning effect. The thickness of the positioning adsorption structure 11 is less than the depth of the first groove 12, to provide a deformation space without affecting the cushioning effect of the cushioning pad 10.

In an embodiment, the body 14 includes a second groove 13. The second groove 13 is a through groove penetrating the body 14.

In this solution, when the display panel 22 is being taken out, the display panel 22 and the cushioning pad 10 stick to each other. A through groove is arranged on the cushioning pad 10 for air ventilation, to prevent the display panel 22 and the cushioning pad 10 from sticking to each other.

In an embodiment, the second grooves 13 are symmetrically distributed. Specifically, the second grooves 13 are distributed in a rectangle, and the second grooves 13 are respectively located at four corners of the rectangle.

In this solution, the second grooves 13 are symmetrically distributed to avoid an adsorption failure of the machine 20 as a result of deformation of the cushioning pad 10 caused by uneven ventilation.

In an embodiment, the cushioning pad 10 includes a first groove 12 and a second groove 13. The first groove 12 and the second groove 13 have different shapes, and the first groove 12 and the second groove 13 are separately distributed.

In this solution, the first groove 12 and the second groove 13 are arranged in different shapes to facilitate observation and distinguish between the two grooves with different functions.

The panel of this application may be a twist nematic panel (TN panel), an in-plane switching panel (IPS panel), a multi-domain vertical alignment (VA) panel. Certainly, the panel may also be other panels of suitable types.

The foregoing content describes this application in detail with reference to the specific implementations, and it should not be regarded that the specific implementations of this application are limited to these descriptions. A person of ordinary skill in the art to which this application belongs can further make simple deductions or replacements without departing from the concept of this application, and such deductions or replacements should all be considered as falling within the protection scope of this application.

What is claimed is:

1. A cushioning pad, comprising:
a body arranged to separate a display panel; and
a positioning adsorption structure arranged on a surface of the body for adsorption by a suction nozzle of a machine, wherein
an upper surface of the positioning adsorption structure corresponding to the suction nozzle is a smooth plane.

2. The cushioning pad according to claim 1, wherein an upper surface area of the positioning adsorption structure is greater than a vacuum adsorption area of the suction nozzle.

3. The cushioning pad according to claim 1, wherein there are at least two positioning adsorption structures.

4. The cushioning pad according to claim 1, wherein the positioning adsorption structures are symmetrically distributed.

5. The cushioning pad according to claim 4, wherein the body comprises a first groove configured to arrange the positioning adsorption structure.

6. The cushioning pad according to claim 5, wherein a thickness of the positioning adsorption structure is less than a depth of the first groove.

7. The cushioning pad according to claim 1, wherein the body comprises a second groove, wherein the second groove is a through groove penetrating the body.

8. The cushioning pad according to claim 7, wherein the second grooves are symmetrically distributed.

9. The cushioning pad according to claim 1, comprising a first groove and a second groove, wherein the first groove and the second groove have different shapes.

10. The cushioning pad according to claim 9, wherein the first groove and the second groove are separately distributed.

11. The cushioning pad according to claim 8, wherein the second grooves are distributed in a rectangle, and the second grooves are respectively located at four corners of the rectangle.

12. The cushioning pad according to claim 1, wherein the body comprises an upper film layer, a lower film layer, and an intermediate layer arranged between upper film layer and the lower film layer.

13. The cushioning pad according to claim 12, wherein the intermediate layer is made of foam.

14. The cushioning pad according to claim 13, wherein the intermediate layer comprises a plurality of circular holes.

15. The cushioning pad according to claim 12, wherein an outer surface of the upper film layer is uneven.

16. The cushioning pad according to claim 12, wherein an outer surface of the lower film layer is uneven.

17. A cushioning pad, comprising:
a body arranged to separate a display panel; and
a positioning adsorption structure arranged on a surface of the body for adsorption by a suction nozzle of a machine, wherein
an upper surface of the positioning adsorption structure corresponding to the suction nozzle is a smooth plane;
an upper surface area of the positioning adsorption structure is greater than a vacuum adsorption area of the suction nozzle;
there are at least two positioning adsorption structures, wherein
the positioning adsorption structures are symmetrically distributed; and
the body comprises a first groove on which the positioning adsorption structure is arranged, wherein
a thickness of the positioning adsorption structure is less than a depth of the first groove.

18. A cushioning apparatus, comprising:
a body arranged to separate a display panel; and
a positioning adsorption structure arranged on a surface of the body for adsorption by a suction nozzle of a machine, wherein
an upper surface of the positioning adsorption structure corresponding to the suction nozzle is a smooth plane.
